(19) United States
(12) Patent Application Publication
(10) Pub. No.: US 2004/0128663 A1
(43) Pub. Date: Jul. 1, 2004

(54) Method and apparatus for thermally managed resource allocation

(76) Inventor: Efraim Rotem, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/331,611

(22) Filed: Dec. 31, 2002

(51) Int. Cl. G06F 9/45

(52) U.S. Cl. 717/161; 717/148; 717/121

(57) ABSTRACT

In some embodiments of the present invention, a method and system are provided in a multiple resource environment for allocating resources for the execution of threads based on the predicted thermal activity of the thread or thread type.

### BACKGROUND OF THE INVENTION

High performance central processing units (CPUs) may integrate multiple processing capabilities, such as cores and/or resources, on a single die. It is desirable to improve the performance of systems using multiple-core CPUs.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic diagram of a multi-resource CPU with thread allocation in accordance with exemplary embodiments of the present invention; and

FIG. 2 is a flowchart of a method for allocating threads in a multi-resource CPU in accordance with one exemplary embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements. It will be appreciated that these figures present examples of embodiments of the present invention and are not intended to limit the scope of the invention.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

High performance central processing units (CPUs) may integrate multiple processing capabilities, i.e., cores and/or resources, on a single die, thereby thermally coupling the cores. Because the processing performance and/or frequency of the individual cores and resources may depend on temperature, the maximum frequency and performance that may be achieved by such integrated CPUs depends on the ability to extract heat from the cores and resources, e.g., using a shared heat sink and a given cooling technology. The cooling capability may also be limited by both the absolute power generated by the device and the power density distribution on the device. Furthermore, many modern operating systems and software have the capability to execute multiple software threads in parallel using more than one processing core.

When running multi-threaded software on a multiple-core CPU, the heat generated by one core may affect the performance of another core. Multiple cores that run simultaneously typically generate more heat than a single core and therefore may run at lower frequency and performance than a single core on the same CPU. Systems using such CPU combinations must generally be equipped to handle the worse-case condition. For example, in the absence of a mechanism to dynamically control the multi-threading power, the frequency must be set to a lower point, one that can accommodate the thermal demands of a multiple core. Therefore, the operation conditions of the system may be limited based on the multi-core condition. Mechanisms such as thermal throttling or mechanisms described in U.S. patent application Ser. No. 10/020,568, entitled “DISTRIBUTION OF PROCESSING ACTIVITY ACROSS PROCESSING HARDWARE BASED ON POWER CONSUMPTION CONSIDERATIONS”, filed Dec. 6, 2001 and assigned to the assignee of this application, provide safety mechanisms. However, even these solutions, which may be adequate in some instances, may often result in reduced performance. Thus single thread operations may not fully utilize the maximum capabilities of the system.

Embodiments of the invention provide a method and a system to manage and/or allocate threads to resources or cores of multiple-core CPUs on a thermally efficient basis and, thereby, to improve the performance characteristics of systems using multiple-core CPUs.

According to an aspect of embodiments of the present invention, in a thermally limited system, tasks or threads are allocated among the cores or resources by a thread allocation unit (TAU) that takes into consideration thermal factors of the threads to be assigned. The TAU may be, for example, a hardware unit on a CPU or a software algorithm in an operating system. By thermally efficient thread allocation, the use of safety mechanisms such as, for example, throttling and other cooling-off techniques, may be reduced, resulting in higher overall efficiency.

The TAU may consider various factors in determining to which core a thread should be allocated for processing. The TAU may, for example, predict or estimate the thermal activity expected to result from a given thread, and allocate it to a resource accordingly. For example, a thread that is expected to generate substantial thermal activity may be allocated to a relatively cooler core. In one embodiment of the present invention, a prediction or estimate of thermal activity due to a given task may for example be based on software or other limits provided by the operating system. In one embodiment of the present invention, a prediction may be based on a table of expected thermal activity associated with different threads or thread types. It should be noted that a TAU may utilize one or more than one or any combination of sources of information in predicting the thermal demands of a requested thread.

In one embodiment of the present invention, the TAU may analyze the cumulative thermal demands of a set of threads to be executed. Thus, for example, a prediction or estimate of the thermal demands of a certain thread may be combined with the thermal demands of at least one other thread to constitute the combined thermal demands of the two threads running simultaneously. If the combined thermal demands of the threads are within a given limit of the CPU, the threads may be executed. Thus, for example, a thread predicted to make high thermal demands may be paired with a thread predicted to make low thermal demands, thereby resulting in sum of power within given thermal limits.

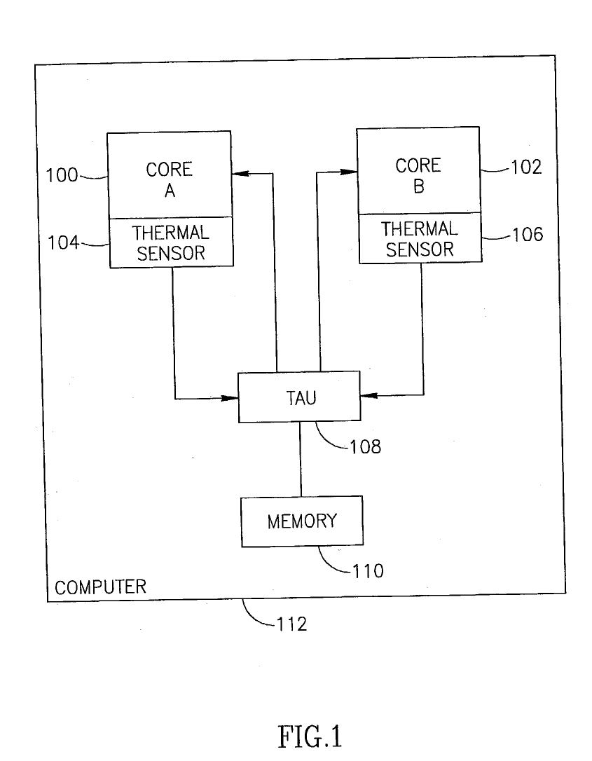

In one embodiment of the present invention, shown in FIG. 1, in a computer 112 there may be provided thermal sensors 104 and 106, respectively, that may monitor or measure the activity and/or thermal status of cores 100 and 102, respectively, of the CPU. It should be noted that as defined herein, a core need not be a full core, but rather may be any resource or execution or processing unit, for example, an integer or floating point decimal multiplier. The thermal sensor may be a power monitor unit, such as an internal diode that translates temperature to an electrical signal, e.g., a voltage, as used in Intel Corporation's Pentium 4 CPU. For example, the power monitor unit may be as described in U.S. patent application Ser. No. 10/020,568.

Typically, a power monitor may be provided for each of the cores or execution Limits providing feedback to thread allocation unit (TAU) 108. The TAU 108 may include, for example, a central or distributed hardware unit on the CPU. Additionally or alternatively, the TAU 108 may include, for example, a software algorithm, which may include, for example, an element of the operating system.

In the embodiment of the invention shown in FIG. 1, TAU 108 may be in communication with a memory 110. Memory 110 may be, for example, dedicated to the TAU, or memory 110 may be general purpose memory used by other functions, or any other suitable memory.

Further, in some embodiments of the invention, the TAU 108 nay include a mechanism to determine the expected thermal demands of threads requested based on the historical thermal activity of the thread or similar threads running on the cores, or the TAU may receive inputs relating to historical core activity or thermal demands of threads. It should be noted that as defined herein, the TAU may be a series of functions distributed between various software and/or hardware components, and need not be a single software program or hardware component. It should further be noted that although FIG. 1 depicts two cores, those skilled in the art will recognize that the same principles of the present invention may be used to provide thermally efficient thread allocation to more than two cores.

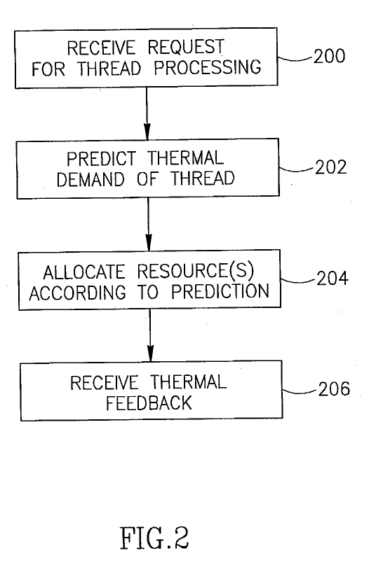

A method in accordance with exemplary embodiments of one aspect of the present invention is shown in FIG. 2. As shown at block 200, a request may be made for the processing or execution of a thread.

At block 202, input(s) may be received relating to prediction of the thermal activity of threads requested to be executed. It should be noted that in other embodiments of the present invention, the prediction of thermal activity of threads may be determined differently, for example, the predictions may be deduced from the thermal activity of a certain core running a certain thread during a predefined processing period. In yet further embodiments of the present invention, the history of high power usage in a thermally significant period of time for certain threads or types of threads may be recorded; thus, determining the thermal activity of threads, which may control the thread allocation, may be based on the historical record of power usage of the same type of thread.

In a further embodiment of the present invention, software hints may be used regarding thermal demands of threads. Software hints may include information about the software threads, e.g., their tendency to heat up the core. Data indicating software hints may be provided to the CPU, for example, from an operating system running on a device associated with the CPU, or pre-stored or periodically downloaded to a memory, such as for example, memory 110 associated with TAU 108 (FIG. 1). Such data may, for example, be contained in registers or data structures. Any item of information about the software thread may be used as a software hint to assist in thermally efficient thread allocation in accordance with embodiments of the invention. In other embodiments of the present invention, the TAU may extract thermal predictions or other information about the process by other means, such as historical activity factors, or it may use the thermal data itself as a heuristic aid.

According to embodiments of the present invention, other heuristic aids may be used to decide thread allocation. Thus, for example, upon determining that a thermal threshold has been reached, as indicated at block 206, feedback data may be sent to the processor, which data may be used, alone or cumulatively in combination with other data, to establish the expected thermal activity of similar threads. It should be noted that any of the above methods or any combination of the above methods and/or any other suitable methods to determine the expected thermal demands of threads may be used to allocate threads to multiple resources in conjunction with embodiments of the present invention.

As indicated at block 204, the TAU may then allocate a thread to a resource for execution based on the thermal prediction made at block 202. The thread allocation may take into consideration device geometry of the multi-core processor. In one embodiment of the present invention, there may be, for example, built-in or pre-programmed look-up-tables that describe the proximity of resources to each other. Additionally or alternatively, there may be, for example, built-in or pre-programmed look-up-tables that describe the order or allocation of resources based on other considerations such as, for example, priority. Some or all of such built-in or pre-programmed look-up-tables may be contained or associated with a memory such as for example memory 110 in FIG. 1.

In some embodiments of the present invention, the TAU may take into consideration dependencies between threads. For example, the TAU may estimate the combined thermal effect of multiple threads and select a set, e.g., two or more, of threads such that the combined power of the set is within a given limit, for example, coupling a high power thread with a low power thread, thereby resulting in a sum of power demands within given limits. It will be understood by those skilled in the art that any combination of these and/or other suitable allocation mechanisms may be used in accordance with the present invention.

In the embodiment shown in FIG. 2, at block 206, the TAU may receive feedback from thermal sensors regarding the thermal condition at the resources executing the threads. This information may then be used to predict the thermal demands of the thread or of similar threads in the future. The feedback may include, for example, a signal responsive to the temperature at a core, and/or measurement of another parameter that may relate to processing activity and/or other measured properties that may relate to a thermal condition. In some embodiments of the invention, the additional property may be gauged by, for example, an event counter that measures the recurrence of events correlated with heating, and may provide a signal responsive to the rate of recurrence of such events.

In one embodiment of the present invention, the TAU may then perform statistical processing of the feedback information based on thread type. In one embodiment of the present invention, threads with high power demands may be tagged or identified as such, and allocated accordingly. In one embodiment of the present invention, a thermal sensor for sensing temperature to detect high power conditions may be used as a power monitor.

While the invention has been described with respect to a limited number of embodiments, it will be appreciated that many variations, modifications and other applications of the invention may be made. Embodiments of the present invention may include other apparatuses for performing the operations herein. Such apparatuses may integrate the elements discussed, or may comprise alternative components to carry out the same purpose. It will be appreciated by persons skilled in the art that the appended claims are intended to cover all such modifications and changes as fall within the true spirit of the invention.

What is claimed is:

1. A method comprising:
allocating a thread for execution by one of at least two thermally-associated resources of a processing unit, based on an expected thermal activity parameter of said thread and a thermal-related parameter of said resources.

2. The method of claim 1, further comprising receiving a feedback input relating to said thermal-related parameter of the one of said resources executing said thread.

3. The method of claim 2, further comprising adjusting said expected thermal activity parameter based on said feedback input.

4. The method of claim 1, wherein said thermal-related parameter comprises a parameter responsive to temperature.

5. The method of claim 1, wherein said thermal-related parameter comprises a parameter responsive to a count of predefined types of events.

6. The method of claim 1, further comprising obtaining said expected thermal activity parameter from an operating system in communication with said processing unit.

7. The method of claim 1, further comprising obtaining said expected thermal activity parameter from a memory unit in communication with said processing unit.

8. An article comprising a storage medium having stored thereon instructions that when executed by a processing platform result in allocating a thread for execution by one of at least two thermally associated resources of a processing unit, based on an expected thermal activity parameter of said thread and a thermal-related parameter of said resources.

9. The article of claim 8, wherein the instructions that result in allocating a thread, when executed, further result in receiving a feedback input relating to said thermal-related parameter of the one of said resources executing said thread.

10. The article of claim 9, wherein the instructions that result in allocating a thread, when executed, further result in adjusting said expected thermal activity parameter based on said feedback input.

11. An apparatus comprising:
a thread allocation unit to allocate a thread for execution by one of at least two thermally associated resources of a processing Lit, based on an expected thermal activity parameter of said thread and a thermal-related parameter of said resources.

12. The apparatus of claim 11, further comprising at least two thermal sensors to monitor said thermal-related parameter of said resources.

13. The apparatus of claim 12, wherein said thread allocation unit is adapted to receive a feedback input from said thermal sensors relating to said thermal-related parameter of the one of said resources executing said thread.

14. The apparatus of claim 13, wherein said thread allocation unit is adapted to adjust said expected thermal activity parameter based on said feedback input.

15. The apparatus of claim 11, wherein said thermal-related parameter comprises a parameter responsive to temperature.

16. The apparatus of claim 11, wherein said thermal-related parameter comprises a parameter responsive to a count of predefined types of events.

17. The apparatus of claim 12, wherein said thermal sensors are power monitors.

18. A computer comprising:
a thread allocation unit to allocate a thread for execution by one of at least two thermally associated resources of a processing unit, based on an expected thermal activity parameter of said thread and a thermal-related parameter of said resources; and
a memory able to communicate with said thread allocation unit.

19. The computer of claim 18, wherein said resources comprise processors of a central processing unit of said computer.

20. The computer of claim 19, further comprising said central processing unit.

21. The computer of claim 20, wherein said memory is able to communicate with said central processing unit.
